(19) United States
(12) Patent Application Publication
(10) Pub. No.: US 2007/0217795 A1
(43) Pub. Date: Sep. 20, 2007

(54) Improvements Relating to Reception in Optical Networks

(75) Inventor: Rob Otte, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,785

(22) PCT Filed: Apr. 11, 2005
(86) PCT No.: PCT/IB05/51180

§ 371 Date: Oct. 10, 2006

(30) Foreign Application Priority Data
Apr. 13, 2004 (GB) 0408122.0

(51) Int. Cl. H04B 10/06; H04B 10/00

(52) U.S. Cl. 398/212; 398/131

(57) ABSTRACT

The present invention relates to a receiver 20 for a free-space optical network. The receiver 20 includes a primary photo detector 12 and a diffuser 13 arranged in the focal plane of an objective lens 11. Auxiliary photo detectors 15a, 15b are arranged to face the diffuser Data reception can take place via the auxiliary detectors 15a, 15b that can move the primary detector 12 to align it with an incoming beam, based on the difference in radiation intensity received at the auxiliary photo detectors 15a, 15b.

The present invention relates to optical networks, and in particular optical receivers in such networks that are adapted for acquisition and tracking of incoming radiation beams.

Free-space optical networks utilize light beams to communicate information between nodes on the network. Each node includes an optical transmitter for sending information to one or more other nodes by way of a modulated radiation beam. Each node also includes a receiver for receiving modulated beams transmitted from one or more other nodes on the network. The radiation beams are usually generated using lasers and may be visible, or have wavelengths outside the visible spectrum. Typically the wavelength is 800-1000 nm, or close to 1550 nm. Free-space optical networks can be implemented on a wide range of scales. Wide area optical networks can be set up, where each node may be several kilometres apart. They can also be implemented for intermediate distances, such as in the interconnection of small local area networks to form a larger network. It is possible, although not usual, for a free-space optical network to be employed in a local area office network.

Radiation beams used in optical networks have a low divergence, which means the beams are highly directional to obtain sufficient speed and optical power margin. Similarly, the receiver has a small field of view. If a receiving node is not sufficiently aligned with the directional output beam of a transmitting node, the receiving node will not “see” the beam, and will not be able to receive communications from that node. Even if nodes are correctly aligned during setup of the network, misalignment can later occur for a variety of reasons. In small scale indoor networks, where nodes are usually desktop computers or similar, movement of the nodes is a likely cause of misalignment. In wide area outdoor networks building sway and earth movement can cause misalignment. The nodes of an optical network therefore usually employ some type of acquisition and/or tracking, where acquisition relates to the initial alignment of nodes during network set up, and tracking relates to the continual realignment of nodes during operation. This enables data communication to take place.

EP 876 021 shows one manner in which tracking is implemented in a receiver. The incoming data beam impinges on a beam splitter, which sends the beam to a photo detector and also a target pattern optical element. The photo detector outputs a signal which is processed to extract data from the beam. The target pattern optical element produces a target pattern, such as intersecting vertical and horizontal beams, that indicates any misalignment between the radiation beam and the receiver. The target is used to realign the receiver. This is just one example of a tracking device that uses a beam splitter arrangement to extract information from the radiation beam, and also uses it for realignment.

U.S. Pat. No. 5,790,291 describes a different arrangement in which the incoming radiation beam is reflected onto a quadrant photo detector with a central aperture. A high speed data photo detector is placed behind the quadrant in line with the aperture. The reflector has a concave surface and focuses the incoming beam into a cone with a focal point. If the focal point is offset from the central aperture, the beam is not focused onto the high speed photo detector. In this event, the output of the quadrant detectors is used to realign the focal point to the centre.

Even if tracking is employed, once the receiver misalignment is too great, the beam misses the receiver optics and realignment can no longer take place. The drawback of systems such as those described above is that their fields of view are relatively narrow. Therefore, it does not require much deviation from the aligned position before the receiver can no longer track the incoming radiation beam and make the necessary adjustments. A small field of view also makes it difficult to implement acquisition. Devices with small fields of view generally have to be pre-aligned, otherwise the receivers and transmitters will never be aligned sufficiently in the first instance, such that tracking can take place. A dead zone can also occur in prior art receivers, whereby a change in pointing error is not detected. This reduces the accuracy of tracking.

Having a small field of view prevents effective data reception in certain circumstances. Reception cannot take place if the receiver is not aligned, and if the misalignment is so great, then tracking and/or acquisition cannot take place to align the receiver so that data reception can take place.

It is an object of the present invention to provide a receiver that provides a relatively wide field of view.

In one aspect, the present invention may be said to consist in a receiver for optical communications including: at least one primary optical detector for receiving radiation from a radiation beam when the radiation beam is aligned with the primary optical detector, and at least one auxiliary optical detector arranged to receive radiation from the radiation beam when the radiation beam is not aligned with the primary optical detector, characterized in that the receiver further includes a diffuser for redirecting radiation towards the auxiliary detector.

The diffuser enables the receiver to have a relatively wide field of view. This provides several potential advantages. First, it allows for adaptations that enable some data reception to take place when the receiver is not aligned, even for multiple transmitters at different angular positions. It also enables adaptations for acquisition and tracking to take place over a wider angle of incidence. The arrangement also enables, if desired, construction with less, relatively cheap and/or simple components. The receiver can be adapted for use in a range of optical networks.

In another aspect the present invention may be said to consist in a receiver for optical communications including: at least one primary optical detector for receiving an incoming radiation beam, a reflecting surface for reflecting an incoming radiation beam, at least one pair of auxiliary optical detectors arranged to receive reflected radiation from the reflecting surface, and a control system connected to the auxiliary detectors for aligning the primary detector and the incoming radiation beam in at least one direction, characterized in that the reflecting surface is a diffuser and the control system aligns the primary detector and radiation beam based on the intensity of reflected radiation received at the auxiliary detectors.

Preferred embodiments of the invention will be described with reference to the following drawings, of which:

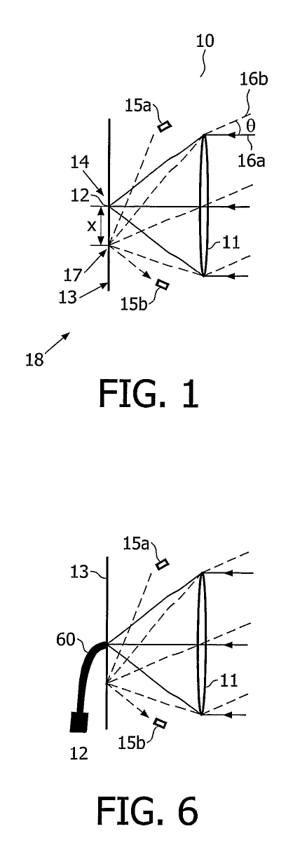

FIG. 1 is a schematic diagram of a portion of an acquisition and tracking optical receiver including a primary detector, a diffuser, a lens and a pair of auxiliary detectors,

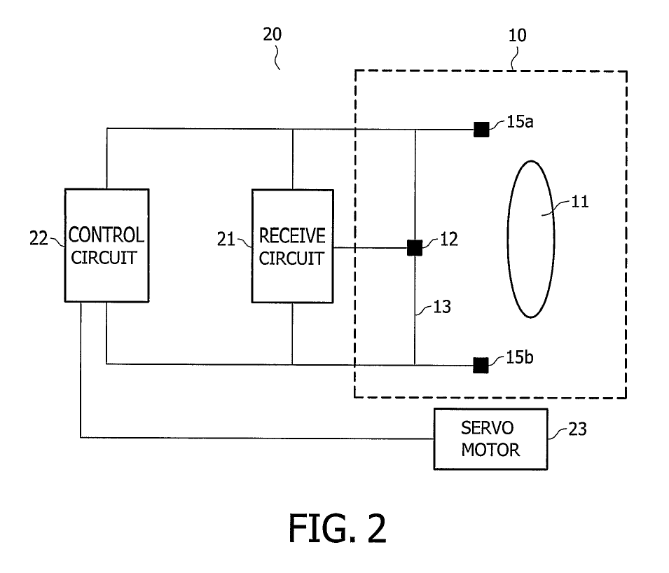

FIG. 2 is a block diagram of a control system for adjusting the receiver,

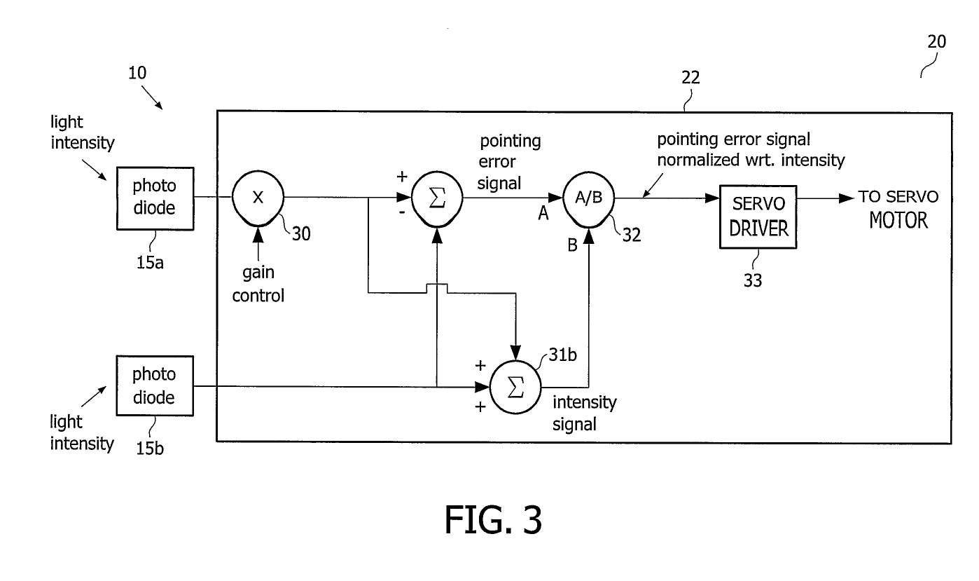

FIG. 3 is a block diagram of a processor in the control system that determines a pointing error signal from the auxiliary detectors,

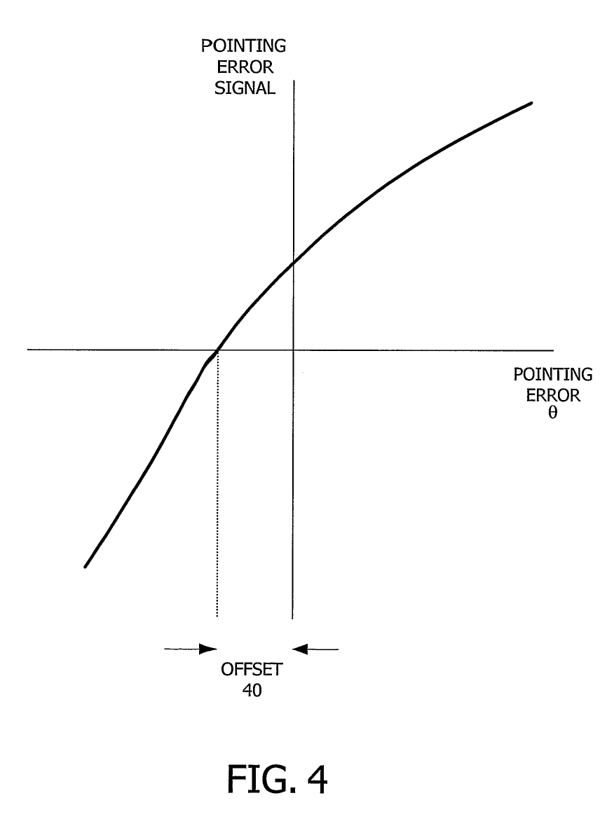

FIG. 4 is a graph showing the relationship between a pointing error and the pointing error signal,

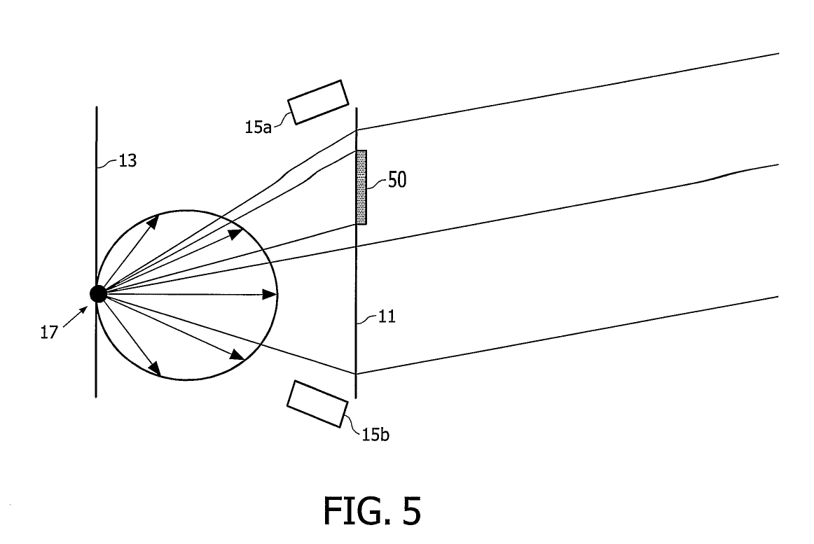

FIG. 5 is a schematic diagram showing the manner in which the diffuser reduces the effects of a blockage on the lens,

FIG. 6 shows an alternative embodiment in which a fibre optic feed couples the primary detector to a focal point, of the lens, and

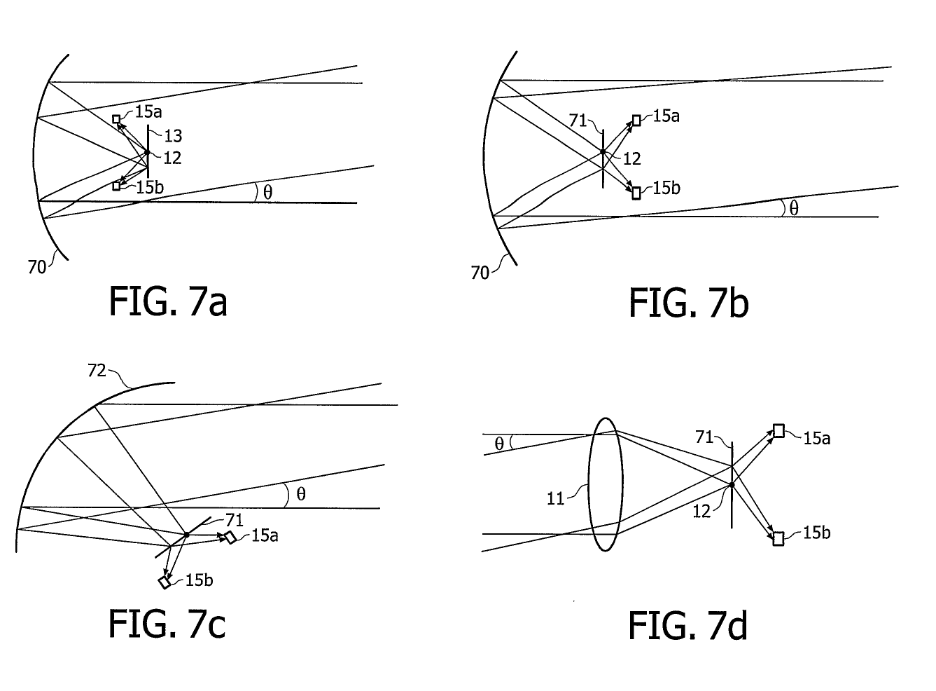

FIGS. 7a-7d are schematic diagrams of alternative arrangements of the optical components of the receiver.

FIG. 1 shows a schematic representation of optical components 10 in a receiving device 20 for an optical network, according to a preferred embodiment of the invention. General details of free-space optical networks are well known in the industry, and therefore will not be described here. In general terms, the receiver 20 is adapted to provide a wide field of view. This enables adaptations to be made for data reception when not aligned and/or acquisition and tracking when employed in a free-space optical network. Each node, such as a computer, on an optical network could utilize one of these receivers for receiving information transmitted optically from other nodes on the network. When misalignment occurs between the receiver and an radiation beam emanating from a transmitting node, some data reception can still take place. This is especially so if a wide beam transmitter is used, as misalignment with the transmitter does not black out the link. Optional acquisition and tracking functionality causes the receiver to realign itself with the radiation beam of the transmitting node. For clarity, FIG. 1 is a side elevation of a receiver set up, which only shows the optical components for adjusting the receiver position in the vertical direction. The following description relates to the case of one dimensional adjustment by referring to FIG. 1. It will be appreciated by those in the art that, in the general case, it is desirable to adjust the receiver in vertical and horizontal directions, as misalignment can occur in two dimensions. The embodiment described can be readily adapted for two dimensional adjustment.

As shown in FIG. 1, the optical portion of the receiver 20 includes an objective lens 11 for focusing an incoming radiation beam, e.g. 16a or 16b, on to a primary optical detector 12, which is placed at or near the focal point 14 of the lens 11. Any suitable lens 11 and optical detector 12 known to those skilled in this technology can be utilized. For example, the optical detector 12 could be one or more photo diodes or any other suitable transducer that converts incoming radiation into an electrical signal. The receiver 10 further includes a projection plane 13 placed around the primary photo detector 11. This assembly 11, 13 is preferably arranged so that the projection plane 13 lies in or close to the field of focus of the lens 11, and the primary detector 12 lies at the focal point 14 of the lens. The projection plane 13 is a diffuser or similar, which reflects incoming radiation diffusely. This means that the incoming radiation is redirected or reflected in various directions from the diffuser, irrespective of the angle of incidence of the incoming radiation. At least one, but preferably a number of auxiliary optical detectors 15a, 15b are located in front of the projection plane 13 to capture diffuse radiation that is reflected from the projection plane. The auxiliary photo detectors 15a, 15b produce an output signal based on the intensity of reflected radiation that is detected. Preferably, the output current is related to intensity, although it can be the output voltage that is related to intensity if current-to-voltage conversion is employed. It will be appreciated that while in the preferred embodiment the diffuser 12 is reflective, in other embodiments it could be transmissive, and redirect radiation to auxiliary detectors behind the diffuser.

FIG. 1 illustrates two possible examples of incoming transmitted beams that a receiver might encounter. Beam 16a, shown in bold lines, is aligned correctly with the receiver such that the focused beam impinges on the primary photo detector 12 at the focal point 14. Any incoming beam, e.g. 16a, modulated with information that is correctly aligned with the primary detector 12, can be received, demodulated and utilized by the node associated with the receiving device 20. It should be noted that in the description, alignment of the receiver strictly refers to alignment of the primary photo detector. In some embodiments, only a portion of the receiver 20 containing the primary detector 12 might actually be adjusted, with the remainder of the receiver remaining stationary.

In contrast, beam 16b (shown in dotted lines), shows another possible scenario, in which the beam comes from some arbitrary angle θ with respect to the receiver 20. The lens focuses this incoming beam 16b at a different point 17 on the focal plane, which coincides with the projection plane 13. In this scenario, the receiver 20 is not aligned with the incoming beam 16b, and the beam is not “seen” by the primary photo detector 12. Reception and processing of data via the primary photo detector 12 cannot take place. Rather, a pointing error occurs θ, which is the difference between the angle of incidence of the incoming beam 16b and the angle of incidence of an aligned beam 16a. This produces an offset x, which is the spatial difference between focused beam 17 on the projection plane 13, and the position of the primary detector 12 at the focal point 14 of the lens. The pointing error θ can be determined based on the intensity of reflected radiation received at each auxiliary detector 15a, 15b. Preferably, a pointing error signal is generated that can be utilized to realign the receiver.

The use of the diffuser 13 enables the receiver 20 to have a relatively wide field of view. Because the diffuser 13 reflects incoming radiation randomly in all directions, even an radiation beam coming from a very wide angle θ will have some portion reflected onto the auxiliary detectors 15a, 15b to enable data reception from a wide angle even when the primary photo detector 12 is not aligned with the beam 16a. Further, it enables tracking and acquisition even when the beam is misaligned to a relatively large extent.

Preferably, the receiver 20 is used in a free-space optical network in which each node has both a primary and an auxiliary transmitter. Preferably, the axis of each beam is substantially coincident. The primary transmitter produces a modulated beam with low divergence for high bandwidth data transmission between nodes. The auxiliary transmitter emits a wide diverging beam, for the purpose of acquisition and tracking, and/or low rate data transmission, as will be described below. If an auxiliary transmitter is used for localizing and possibly identifying a node, then it is known as a beacon. The receiver 20 according to the invention has a relatively wide field of view, which enables use of a wide beam auxiliary transmitter. The auxiliary transmitter could be one or more LEDs. High sensitivity can be obtained by small bandwidth coherent detection. If the signal-to-noise ratio is sufficiently high, for example by reducing bandwidth, low data rate communication can take place using the auxiliary beam. This could be used, for example, for the purpose of transmitting information for network setup and control. By allocating different channels to different nodes, the receiver is able to determine the directions of multiple other nodes, and to communicate with them in order to negotiate network setup and control.

The receiver 20 detects misalignment from a node using the incoming auxiliary beam from that node. As a result of aligning the receiver 20 with the auxiliary beam, the receiver is also aligned with the data beam. The auxiliary beam preferably includes some type of beacon signal or pilot tone to enable the auxiliary detectors 15a, 15b to distinguish the reflected beam from ambient radiation. It will be appreciated that the receiver 20 can be used in a network in which the transmitters only use a narrow data beam.

FIG. 2 is a block diagram showing a preferred embodiment of the entire optical receiver 20, illustrating the manner in which the optical components 10 are interconnected with receiver 21 and control circuitry 22. The componentry in FIG. 2 allows for tracking and acquisition, and wide angle data reception to take place using the optical arrangement in FIG. 1. The output of the primary detector 12 is connected to receiver circuitry 21, which carries out the necessary demodulation and other processing to extract information modulated onto the incoming beam. The output from the receiver circuitry 21 can then be utilized as required by a network node (not shown in FIG. 2) connected to the receiver 20. Details of the receiver circuitry 21 will be known to those skilled in this technology, and therefore need not be described further. Each auxiliary photo detector 15a, 15b outputs a voltage or current related to the intensity of radiation it detects, and passes this to the receiver circuitry 21 and also control circuitry 22. The control circuitry 22 processes the output of the auxiliary detectors 15a, 15b to determine a pointing error signal that indicates the magnitude of misalignment x between the arbitrary incoming beam 16b and the primary detector 12. The control circuitry 22 is connected to one or more servo motors 23 that can adjust the orientation of the receiver. The control circuitry 22 instructs the servo motors 23 to realign the receiver with the incoming beam, e.g. 16b, based on the pointing error signal. Together, the control circuitry 22 and the servo motors 23 form a control system for the receiver 20. The reflected radiation received by the auxiliary detectors 15a, 15b may also contain data, which can be retrieved by the receiver circuitry 21 in the usual manner.

Referring to FIGS. 1 and 2, a preferred operation of the receiver to effect realignment will be described in detail. An incoming beam, e.g. 16b, that is not aligned with the receiver, will have a pointing error θ, producing an offset x. The incoming beam 16b, is focused 17 onto the projection plane 13, and is then reflected diffusely such that energy from the beam is reflected randomly in various directions. Each auxiliary photo detector in a pair, e.g. 15a, 15b receives a portion of this reflected radiation, and produces an output current based on the intensity of received radiation. The intensity of radiation received is dependent on the distance between the respective detector 15a, 15b and the point 17 on the projection plane 13 from where the radiation was reflected. Nominally, if the reflection spot 17 is equi-distant from the detectors 15a, 15b, each detector receives radiation of equal intensity, which correlates to a zero pointing error signal as is the case for beam 16a shown in FIG. 1. This is the special case where the receiver 20 is aligned with the transmitter in the vertical direction.

In the general case, the reflection spot 17 will be closer to one detector than the other, in which case each detector will receive a different intensity of radiation, which correlates to a non-zero pointing error signal. For example, as shown in FIG. 1, the reflected radiation from beam 16b coming from angle θ will be closer to and therefore more intense at detector 15b, and further from and less intense at detector 15a. The difference in intensity correlates to the offset x from the aligned position 14, and the magnitude of the difference indicates the offset is downwards as viewed in the diagram. The pointing error signal 17 is generated in the control circuitry 22 from the difference in the current output by auxiliary detectors 15a, 15b. The magnitude of this difference indicates the pointing error x, and the sign of the difference indicates the direction of misalignment. From this, the control circuitry 22 generates a signal that is passed to the servo motor 23. The servo 23 rotates or otherwise moves the optics of the receiver in the direction of arrow 18 to bring the primary photo detector 12 into alignment with the incoming beam 16b, or at least to minimize the pointing error θ. Alternatively, the servo motor 23 could alter the angle of incidence of the incoming beam by moving a redirection element that is positioned in the path of the incoming beam. This would also have the effect of aligning the primary detector 12 with the beam 16b. The redirection element could be, for example, a mirror or lens.

As shown in FIGS. 1 and 2, the receiver 20 includes one pair of auxiliary photo detectors 15a, 15b for determining an alignment error in the vertical direction. To detect and correct misalignment in the perpendicular horizontal direction, another pair of auxiliary photo detectors could be employed, and coupled to control circuitry. In the case of two pairs of detectors, preferably each is arranged along respective axes that have an origin at the focal point 14 of the lens 11, although this is not essential. Each pair of detectors can be arranged along any line in the direction of the misalignment they are detecting. It will also be appreciated that while a pair of photo detectors is sufficient, three or more auxiliary photo detectors could be used for determining more accurately receiver 20 misalignment along a particular axis.

Operation of the control circuitry 22 will be explained in detail with reference to the block diagram shown in FIG. 3. The output of each detector 15a, 15b is coupled to a pair of summers 31a, 31b. The output from one of the detectors, e.g. 15a, may be optional coupled to the summers 31a, 31b via a gain control device 30. The first summer 31a outputs the difference between the output signals from detectors 15a, 15b. This is the pointing error signal. The second summer 31b outputs an intensity signal which is the sum of the output signals from detectors 15a, 15b. A divider 32 divides the pointing error signal by the intensity signal to produce a normalized pointing error signal. Some modulation and synchronous detection technique may be used to remove the effect of ambient radiation. This will be known to those in the art and therefore is not shown in FIG. 3. The normalized error signal is passed to a servo driver 33, which generates output signals in accordance with the error signal to operate the servo motor 23.

FIG. 4 shows a typical relationship between the pointing error signal and the pointing error θ. In the ideal case, when the receiver is aligned 20, each auxiliary detector 15a, 15b will detect reflected radiation of the same intensity. As the reflected spot moves, e.g. 17, the relationship between the pointing error signal and the pointing error, e.g. x, will ideally be linear. However, in practice, various factors combine to produce a non-linear relationship between the pointing error signal and pointing error and/or an offset 40, as shown in FIG. 4. These factors include non-linear light-to-current conversion in the detectors, unmatched detectors with different nominal characteristics, and non-symmetrical positioning and alignment of the detectors in the receiver. The offset 40 is primarily due to mismatched detectors, that is, detectors with nominally different characteristics. This is implementation dependent, and mounting accuracy of detectors may play a role. Mismatched detectors result in a pointing error signal being determined, even when the receiver is aligned, and more importantly, a receiver that is not appropriately pointed when the control loop drives the error to zero. The offset 40 can be minimized by ensuring the characteristics of the auxiliary detectors 15a, 15b are as close as possible, and by correcting any residual offset by adjusting the gain control 30 shown in FIG. 3. The non-linearity can be corrected by means of a conversion table, as known in the art.

In existing technology, beams coming from a wide angle cannot be detected, unless detectors are placed widely apart to capture the reflected beams or direct beams. This usually requires multi-detector arrays, which introduces associated dead spots due to detector packaging, and also can increase the complexity and/or cost of the receiver.

Because the projection plane 13 reflects diffusely, and because it is placed in or in proximity to the focal plane, the position of the focus point 17 as it appears to the auxiliary detectors 15a, 15b, does not depend on any partial blocking, such as dirt, on the lens. FIG. 5 shows the effects of dirt on the lens. The diffuser 13 reflects incoming radiation at all angles, which reduces any blind spot in the reflection pattern due to the dirt 50 on the lens 11 blocking rays coming from that direction. If a standard mirror were used, a dead spot would occur in the reflection pattern corresponding to the angle of incidence of rays blocked by the dirt 50. For example, if a standard mirror were used in FIG. 5, a dead spot would occur in the bottom half of the reflection pattern corresponding to the dirt 50 on the top half of the lens. Using a diffuser 13 placed in the focal plane to counter dirt 50 on the lens 11 means that the auxiliary detectors 15a, 15b do not need to be placed in or close to the focal plane, which some existing receivers use. Therefore, shading by the packaging or edges of the detectors can be avoided, resulting in a reduced or non existent dead zone. The dead zone is the area of incident angles for which there is no error signal generated because the optical path in the auxiliary system is disturbed.

FIG. 6 shows another embodiment of the invention that further minimizes the dead zone. The primary detector 12 is coupled to the focal point 11 by an optical fibre 60. In this case, the packaging of the data detector 12 does not disturb the operation of the auxiliary detection system. Therefore, even when properly aligned, the present system allows some radiation to reflect back from the data detector so that the auxiliary detector system remains operational.

Using a wide auxiliary transmitter beam and having a receiver with a wide field of view, manual pre-alignment can be avoided, simplifying installation. Further, it is possible for receivers on multiple different nodes to detect the same transmitting node and communicate with it using just the wide auxiliary beam, and data transmitted by that beam. Using a wide field of view increases the area that the receiver can cover, and hence the number of transmitters it can communicate with. The ability to determine the error sign and magnitude, and linearize that error, as described earlier, makes it possible to determine the direction of a transmitter without actually directing at it. This enables multiple transmitters to be located and communicated with simultaneously.

In the case of a node with a bidirectional link, each node has both a receiver and transmitter. For a particular node, the receiver 20 can be mechanically mounted with the transmitter on that node. When the first node aligns its receiver with the incoming beam from a second node in accordance with the invention, the transmitter of the first node is also aligned with the receiver of the second node.

The arrangement according to the preferred embodiment optionally enables independent receiver circuitry to be employed for the auxiliary and primary detectors. The circuitry 21 is shown as one entity in FIG. 2 for clarity, but in fact may be separated into distinct data and auxiliary receive circuitry. This enables different design criteria of the respective electronics, and in particular the preamplifiers, of the data receiver circuit and the auxiliary receiver circuit. This means the design can be specialized for each section, reducing the need for engineering comprises or unnecessary over-engineering. For example, the auxiliary receiver has a wide field of view, and so receives a large quantity of ambient radiation. The noise level is usually determined by the ambient radiation so the noise performance of the preamplifier is not very critical. However, its bias circuit needs to drain high DC photocurrent. The bandwidth need not be high, but the matching between the auxiliary channels should be good to prevent tracking offset. These design criteria can be met without comprising on the high speed low noise requirements of the data detector circuitry. Further, the actual components used for each can be selected and optimized individually for speed versus cost. For example, the auxiliary detectors can be small surface low cost standard types. The data detector can be a fibre optics type. The field of view can be adapted to suit the application, for example indoor connectivity or outdoor network, without redesign of the detectors.

FIGS. 7a-7d show various alternative embodiments of the optical element assembly.

FIG. 7a shows an alternative embodiment of the invention, in which the lens 11 is replaced with an alternative focusing element. A parabolic reflector 70 is used to perform the focusing, while the diffuser 13, primary detector 12 and auxiliary detectors 15a, 15b are arranged in a similar manner to that shown in FIG. 1. The diffuser 13 and primary detector 12 are arranged to face the reflector 70, so that the incoming beam 16a incident on the reflector 70, is redirected to the diffuser 13 and primary detector 12.

FIG. 7b shows an alternative embodiment in which a transmissive diffuser 71 is used. In this embodiment, the primary detector 12 faces the reflector 70, and the auxiliary detectors 15a, 15b are placed behind the transmissive diffuser 71. The incoming beam 16a is redirected by the reflector 70, passes through the diffuser 71, and part of the radiation is redirected to the auxiliary detectors 15a, 15b. It will be appreciated that a transmissive diffuser 71 could alternatively be used in an arrangement with a lens 11, rather than a reflector 70.

FIG. 7c shows an alternative embodiment in which the diffuser/detector arrangement is offset. In this embodiment, the reflector 72 is arranged with a ground plane 73 to redirect incoming radiation onto the primary detector 12 and diffuser 71, which are not positioned “square on” to the reflector 72. This prevents radiation rays destined for the reflector 71 being blocked by the diffuser/detector assembly. It will be appreciated that a reflective diffuser 13 could also be used in this arrangement instead, with the auxiliary detectors 15a, 15b being placed between the reflector 72 and the diffuser 13.

FIG. 7d shows an alternative embodiment in which a lens 11 is used with a transmissive diffuser 71. The primary detector 12 faces the lens 11, which the auxiliary detectors 15a, 15b are placed behind the diffuser 71. Radiation from the lens 11 passes through the diffuser 71 and a portion of the radiation is redirected onto the auxiliary detectors.

The preferred embodiment is for use with visible or infrared radiation, but it will be appreciated that invention can be used for communicating using electromagnetic radiation of any wavelength, for example microwaves. The term “optical” or “light” in the specification should not be considered to just refer to visible or infrared electromagnetic radiation.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A receiver (20) for optical communications including:
at least one primary optical detector (12) for receiving radiation from a radiation beam (16a) when the radiation beam is aligned with the primary optical detector (12), and
at least one auxiliary optical detector (15a) arranged to receive radiation from the radiation beam (16b) when the radiation beam is not aligned with the primary optical detector (12),
characterized in that the receiver (20) further includes a diffuser (13; 71) for redirecting radiation towards the auxiliary detector.

2. A receiver according to claim 1 including a focusing element (11; 70) for focusing the incoming radiation beam (16b) onto the primary optical detector and/or the diffuser.

3. A receiver according to claim 2 including a receiver system (21) for retrieving data from redirected radiation received at the auxiliary detector.

4. A receiver according to claim 1 wherein the diffuser is a reflector and is arranged to face substantially in the same direction as the primary detector to reflect incoming radiation not aligned with the primary detector, and the auxiliary detector is arranged to substantially face the diffuser.

5. A receiver according to claim 4 wherein the diffuser is arranged in substantially the same plane as the primary detector, and the diffuser and primary detector are positioned in or in proximity to the focal plane of the focusing element.

6. A receiver according to claim 2 including a control system (22, 23) connected to the auxiliary detector for aligning the primary detector with respect to the radiation beam in at least one direction based on the intensity of radiation received at the auxiliary detector.

7. A receiver according to claim 6 wherein the control system aligns the primary detector with the radiation beam by moving the primary detector.

8. A receiver according to claim 6 further including a redirecting element arranged in the path of the incoming beam, wherein the control system aligns the primary detector with the radiation beam by moving the element.

9. A receiver according to claim 1 including at least one pair of auxiliary detectors (15a, 15b), each auxiliary detector being arranged to output current dependent on the intensity of received radiation, and the receiver includes means for calculating misalignment of the primary detector with respect to the radiation beam based on the output signals of each auxiliary detector (15a, 15b).

10. A receiver according to claim 9 including two pairs of auxiliary detectors, wherein the calculating means is connected to both pairs of detectors for calculating misalignment of the primary detector with respect to the radiation beam in two substantially perpendicular directions.

11. An optical network including a plurality of nodes, a first said node including a receiver according to any preceding claim and a second said node including a transmitter for transmitting a radiation beam to be received by said receiver.

12. An optical network according to claim 11, said first node including both a transmitter for transmitting a radiation beam and a receiver and said second node including a receiver, wherein the first node is arranged to align the radiation beam output from the transmitter on the first node with respect to the receiver on the second node, based on a signal output from the receiver in said first node.

13. An optical network according to claim 11 wherein the second node is arranged to transmit a relatively narrow divergence data beam and relatively wide divergence auxiliary beam, and wherein the receiver in the first node is arranged to align the primary detector with respect to the auxiliary radiation beam.

14. An optical network according to claim 13 wherein the network is arranged such that aligning the primary detector with respect to the auxiliary radiation beam also aligns the primary detector with the data beam from the second node.

15. A receiver (20) for optical communications including:
at least one primary optical detector (12) for receiving an incoming radiation beam,
a redirecting surface (13) for redirecting an incoming radiation beam (16b),
at least one pair of auxiliary optical detectors (15a, 15b) arranged to receive redirected radiation from the surface (13), and
a control system connected to the auxiliary detectors (15a, 15b) for aligning the primary detector (12) and the incoming radiation beam (16b) in at least one direction,
characterized in that the surface (13) is a diffuser and the control system aligns the primary detector (12) and radiation beam (16b) based on the intensity of redirected radiation received at the auxiliary detectors (15a, 15b).
